(19) United States
(12) Patent Application Publication
(10) Pub. No.: US 2020/0041981 A1
(43) Pub. Date: Feb. 6, 2020

(54) CONTROL DEVICE, ELECTRONIC DEVICE, AND CONTROL METHOD

(71) Applicant: SHARP KABUSHIKI KAISHA, Sakai City (JP)

(72) Inventor: EITAROH AKASHI, Sakai City (JP)

(21) Appl. No.: 16/526,533

(22) Filed: Jul. 30, 2019

(30) Foreign Application Priority Data
Aug. 2, 2018 (JP) 2018-145801

(51) Int. Cl. G05B 19/416; H04B 17/318

(52) U.S. Cl. CPC G05B 19/416; H04L 5/14; H04B 17/318

(57) ABSTRACT

A control device configured to control an operation of a motor includes: a communication state detecting section configured to detect a communication state of a communication device; and an operation control section configured to restrain the operation of the motor in a case where received power of a signal externally received by the communication device is less than a predetermined threshold.

This Nonprovisional application claims priority under U.S.C. § 119 on Patent Application No. 2018-145801 filed in Japan on Aug. 2, 2018, the entire contents of which are hereby incorporated by reference.

### TECHNICAL FIELD

The present invention relates to a control device for controlling an operation of a motor.

### BACKGROUND ART

There are known conventional techniques with which a control device for controlling an operation of a motor carries out control based on communication with an external device. There are also known techniques for restrain an effect, on communication, of an operation of a motor. For example, Patent Literature 1 discloses a side mirror drive mechanism which uses a piezoelectric actuator as a motor for adjusting an angle of a mirror in a vehicle side mirror, so that an antenna module provided in the vehicle side mirror carries out stable communication.

### CITATION LIST

### Patent Literature

[Patent Literature 1]

Japanese Patent Application Publication Tokukai No. 2009-241735 (Publication date: Oct. 22, 2009)

### SUMMARY OF INVENTION

### Technical Problem

The conventional techniques above allow stable communication. However, with the conventional techniques above, it is not possible to use brushed motors which are widely used. Therefore, due to limitations such as cost and installation space, it is unfortunately not possible to apply the conventional techniques above to a configuration in which a brushed motor needs to be used.

An aspect of the present invention has been made in view of the problem, and it is an object of an aspect of the present invention to provide a control device and the like having a high degree of design freedom.

### Solution to Problem

In order to attain the object, a control device in accordance with an aspect of the present invention is a control device for controlling an operation of a motor, including: a communication state detecting section configured to detect a communication state of a communication device; and an operation control section configured to control the operation of the motor, the operation control section being configured to restrain the operation, in a case where received power of a signal, which is externally received by the communication device, is less than a predetermined threshold.

A control device in accordance with an aspect of the present invention is a control device for controlling an operation of a communication device, including: an operation state detecting section configured to detect an operation state of a motor; and a communication control section configured to control the operation of the communication device, the communication control section being configured to restrain reception of a signal by the communication device while the motor is operating.

An electronic device in accordance with an aspect of the present invention is an electronic device including: at least one communication device; at least one motor; and at least one control device, the at least one control device being configured to carry out: a communication state detecting process of detecting a communication state of the at least one communication device; and an operation control process of controlling an operation of the at least one motor, in the operation control process, the operation is restrained in a case where received power of a signal, which is externally received by the at least one communication device, is less than a predetermined threshold.

A control method in accordance with an aspect of the present invention is a method of controlling an electronic device, the electronic device including: at least one communication device; at least one motor; and at least one control device, the method including the steps of: (a) detecting a communication state of the at least one communication device; and (b) controlling an operation of the at least one motor, the step (b) being carried out so as to restrain the operation in a case where received power of a signal, which is externally received by the at least one communication device, is less than a predetermined threshold.

### Advantageous Effects of Invention

With an aspect of the present invention, it is advantageously possible to provide a control device or the like having a high degree of design freedom.

### BRIEF DESCRIPTION OF DRAWINGS

FIG. 1 is a block diagram illustrating main components of a robot in accordance with Embodiment 1 of the present invention.

FIG. 2 is a view schematically illustrating an appearance of the robot in accordance with Embodiment 1 of the present invention.

FIG. 3 is a flowchart illustrating a flow of a process carried out by the robot in accordance with Embodiment 1 of the present invention.

FIG. 4 is a set of views schematically illustrating frame structures of communication frames for use in a TDD method. (a) of FIG. 4 illustrates a frame structure in a case where (i) one frame is 10 ms and (ii) a reception segment is approximately 4.5 ms. (b) of FIG. 4 illustrates a frame structure in a case where (i) one frame is 10 ms and (ii) a reception segment is approximately 7.5 ms. (c) of FIG. 4 illustrates a frame structure of a communication frame which (i) is configured so that one frame is 10 ms and (ii) is used in actual communication.

FIG. 5 is a flowchart illustrating a flow of a process carried out by a robot in accordance with Embodiment 2 of the present invention.

FIG. 6 is a flowchart illustrating a flow of a process carried out by a robot in accordance with Embodiment 3 of the present invention.

### DESCRIPTION OF EMBODIMENTS

### Embodiment 1

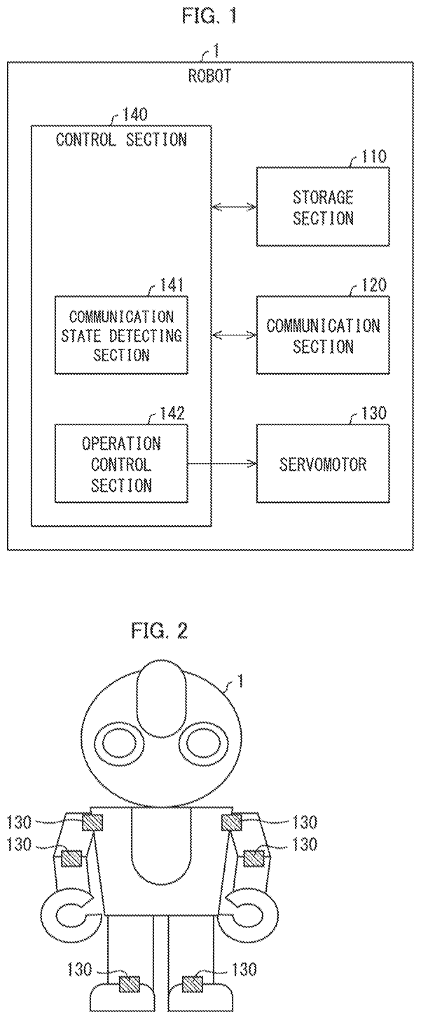

The following description will discuss, in detail, an embodiment of the present invention with reference to FIGS. 1 through 3.

(Overview of Robot)

An overview of a robot 1 in accordance with Embodiment 1 of the present invention will be described below with reference to FIG. 2. FIG. 2 is a view schematically illustrating an appearance of the robot 1. In an example of FIG. 2, the robot 1 is a humanoid robot which includes (i) a control device (described later) and (ii) servomotors 130 provided in respective parts of the robot 1. With the configuration of the robot 1, the control device controls the servomotors 130 to carry out respective various operations. The robot 1 further includes a communication section 120 (described later so that the robot 1 can also serve as an electronic device to or from which a signal is transmitted or received, respectively.

Note that the servomotors 130 are not specifically limited, provided that each of them is configured to allow the robot 1 to carry out an operation under control of the control device. For example, each of the servomotors 130 can be a brushed motor which generates, while operating, a radio wave that causes a noise to a signal received/transmitted by the communication section 120.

In accordance with received power of a signal externally received by the communication section 120, the robot 1 restrains operations of the respective servomotors 130 so as to restraint magnitudes of noises generated by the respective servomotors 130. Restraint of an operation can be restraint of any element including an operation speed, provided that a magnitude of noise to be generated by the operation can be restrained. For example, in a case where the servomotors 130 are respective brushed motors, the robot 1 restrains a generation of noise by restraining rotation speeds of the respective brushed motors. Specifically, in a case where a received power is less than a predetermined threshold, the robot 1 restrains an operation of each of the servomotors 130. This allows an S/N ratio, which varies depending on the received power and on a magnitude of noise, to be maintained at a value suitable for communication.

With the control, the robot 1 in accordance with Embodiment 1 can simultaneously carry out (i) various operations carried out with use of the servomotors 130 and (ii) transmission and reception of signals with use of the communication section 120. That is, the robot 1 is configured so that, even in a case where noise is generated by the respective operations of the servomotors 130, the communication section 120 can carry out a stable communication. In other words, even in a case where the servomotors 130, which generate noises during respective operations, are employed in the robot 1, the control device of the robot 1 can maintain an S/N ratio suitable for the communication carried out by the communication section 120. With the configuration of Embodiment 1, various members can therefore be used as the respective servomotors 130 without the need for consideration of the amount of noise to be generated. It follows that Embodiment 1 can provide a control device with a high degree of design freedom.

(Configuration of Robot)

A configuration of the robot 1 in accordance with Embodiment 1 of the present invention will be described below with reference to FIG. 1. FIG. 1 is a block diagram illustrating main components of the robot 1.

The robot 1 includes a storage section 110, the communication section 120, a single servomotor 130, and the control section 140. The control section 140 includes a communication state detecting section 141 and an operation control section 142.

The storage section 110 stores therein various kinds of information to be handled by the robot 1. The storage section 110 stores therein, for example, an operation program (not illustrated). The operation program is read out by the control section 140 so as to be used for, for example, (i) communication with use of the communication section 120 or (ii) an operation with use of the servomotor 130.

The communication section 120 serves as a communication device which communicates with an external device under the control of the control section 140. The communication section 120 is not limited to a specific one, provided that the communication section 120 can carry out transmission and reception with an external device. For example, the communication section 120 can employ any communication method. In regard to a state of the communication carried out by the communication section 120, various detections and determinations are carried out by the communication state detecting section 141 (described later).

The servomotors 130 are motors provided at the respective parts of the robot 1. The servomotors 130 each operate under the control of the operation control section 142. In the example of FIG. 1, a single servomotor 130 is illustrated. Alternatively, as illustrated in FIG. 2, the robot 1 can include a plurality of servomotors 130. In this configuration, the operation control section 142 can control the robot 1 to carry out a predetermined operation by combining operations of the respective plurality of servomotors 130.

The servomotor 130 can restrain an operation or cancel the restraint of the operation under the control of the operation control section 142. Note that the restraint of the operation corresponds to, for example, setting an upper limit to a rotation speed of the servomotor 130. By restraining the rotation speed or by stopping the rotation, it is possible to restrain the magnitude of noise generated by the rotation of the servomotor 130.

The control section 140 can comprehensively control sections of the robot 1. For example, the control section 140 can (i) read out, from the storage section 110, an operation program concerning the operation of the robot 1 and (ii) (issue, based on the operation program thus read out, instructions to the communication state detecting section 141 and to the operation control section 142.

In a case where a value of received power of a signal externally received by the communication section 120 is less than a predetermined threshold, the control section 140 instructs the operation control section 142 to restrain the operation of the servomotor 130. This is because a suitable S/N ratio can be maintained by restraining the operation of a servomotor 130 in a case where, since received power of a signal externally received by the communication section 120 is weak, an S/N ratio is assumed to deteriorate due to a noise generated by the operation of the servomotor 130.

The communication state detecting section 141 operates in accordance with an instruction of the control section 140, so as to detect a communication state of the communication section 120. The communication state detecting section 141 detects received power of a signal externally received by the communication section 120, and then can notify the control section 140 of the received power.

The communication state detecting section 141 can detect, for example, a period of time in which the communication section 120 receives a signal from an external device. For example, the communication state detecting section 141 (i) figures out a timing, a period of time, and the like which the communication section 120 externally receives, and can then notify the control section 140 of the timing, the period of time, and the like thus figured out.

The operation control section 142 operates in accordance with an instruction of the control section 140, so as to control the operation of the servomotor 130. The operation control section 142 can restrain the operation of the servomotor 130, in a case where received power of a signal, which is externally received by the communication section 120, is less than a predetermined threshold. While the communication section 120 is receiving a signal externally received, the operation control section 142 can restrain the operation of the servomotor 130.

The operation control section 142 can cancel the restraint, in a case where, while the restraint of the operation of the servomotor 130 is being carried out: (i) the received power of the signal externally received is no longer less than the predetermined threshold or (ii) the communication section 120 stops carrying out communication. That is, the operation control section 142 controls so as to cancel the restraint of the operation of the servomotor 130, in a case where, despite the cancellation of the restraint, a noise generated by the servomotor 130 has little effect on the communication of the communication section 120, so that a suitable S/N ratio can be maintained.

(Flow of Process)

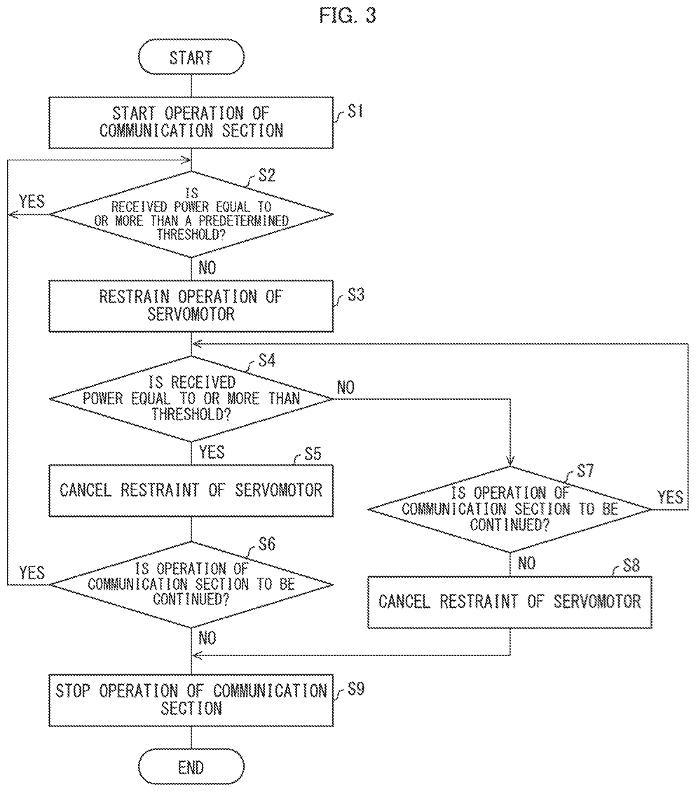

A flow of a process carried out by the robot 1 in accordance with Embodiment 1 of the present invention will be described below with reference to FIG. 3. FIG. 3 is a flowchart illustrating the flow of a process carried out by the robot 1.

First, the communication section 120 starts an operation in accordance with an instruction of the control section 140 (S1). Then, the communication state detecting section 141 detects received power of a signal externally received by the communication section 120. The communication state detecting section 141 then determines whether or not the received power is equal to or more than a predetermined threshold (S2: communication state detecting step). In a case where the received power is not equal to or more than the predetermined threshold, i.e., the received power is less than the predetermined threshold (NO in S2), the operation control section 142 carries out restraint of the operation of the servomotor 130 under an instruction of the control section 140 (S3: operation controlling step).

Then, again, the communication state detecting section 141 detects received power of the signal externally received by the communication section 120. Then, the communication state detecting section 141 determines whether or not the received power is equal to or more than the predetermined threshold (S4: communication state detecting step). In a case where the communication state detecting section 141 determines that the received power is equal to or more than the predetermined threshold (YES in S4), the operation control section 142 cancels the restraint of the operation of the servomotor 130 under the control of the control section 140 (S5: operation controlling step). Subsequently, the control section 140 determines whether or not the operation of the communication section 120 is to be continued (S6). In a case where the control section 140 determines that the operation of the communication section 120 is to be continued (YES in S6), the process proceeds to S2, and the process proceeds to S2 through S6 again. In contrast, in a case where the control section 140 determines that the operation of the communication section 120 is not to be continued (NO in S6), the process proceeds to S9.

In a case where the communication state detecting section 141 determines in S4 that the received power is not equal to or more than the predetermined threshold (NO in S4), the control section 140 determines whether or not the operation of the communication section 120 is to be continued (S7). In a case where the control section 140 determines that the operation of the communication section 120 is to be continued (YES in S7), the process proceeds to S4, and then the process proceeds to S4 through S7 again. In contrast, in a case where the control section 140 determines that the operation of the communication section 120 is not to be continued (NO in S7), the operation control section 142 cancels, in accordance with an instruction of the control section 140, the restraint of the operation of the servomotor 130 (S8: operation controlling step). Then, the process proceeds to S9.

In S9, the communication section 120 stops the operation under the control of the control section 140 (S9). Then, the process ends.

The robot 1 in accordance with Embodiment 1 thus carries out restraint of an operation of the servomotor 130, in a case where received power of a signal received by the communication section 120 from an external device is less than a predetermined threshold. Then, in a case where the received power becomes equal to or more than the predetermined threshold after the restraint of the operation has been carried out, it is possible to cancel the restraint. This makes it possible to restrain generation of noise in a case where received power is decreased. Therefore, it is advantageously possible to provide a robot 1 having a high degree of design freedom because it includes a control section 140 capable of maintaining a suitable S/N ratio even in a case where, for example, a servomotor 130 which generates large noise is used.

Note that the flowchart above illustrated the configuration in which restraint of an operation of the servomotor 130 is cancelled, in a case where (i) received power becomes equal to or more than a predetermined threshold after the restraint has been carried out or (ii) the operation of the communication section 120 is not to be continued. However, in a case where, for example, the communication section 120 is not receiving the signal after restraint of the operation of the servomotor 130 has been carried out, it is unnecessary to consider a noise to the signal. The restraint can therefore be cancelled.

### Embodiment 2

Embodiment 2 of the present invention will be described below with reference to FIGS. 1 , 4, and 5. For convenience, members which are identical in function to the members described in Embodiment 1 will be given respective identical reference signs, and descriptions of those members will not be repeated.

(Configuration of Robot)

A configuration of a robot 1 in accordance with Embodiment 2 is basically identical to that of the robot 1 in accordance with Embodiment 1 except part of the configuration. According to Embodiment 2, a communication method used by a communication section 120 for transmitting and receiving signals includes at least a time division duplex (TDD) method. A configuration of a communication state detecting section 141 differs from that of Embodiment 1 in that the communication state detecting section 141 further detects the communication method used by the communication section 120 for transmitting and receiving signals. A configuration of an operation control section 142 differs from that of Embodiment 1 in that the operation control section 142 restrains an operation of a servomotor 130 in a case where i) the communication method used by the communication section 120 for transmitting and receiving signals is the TDD method and (ii) the communication section 120 can externally receive a signal.

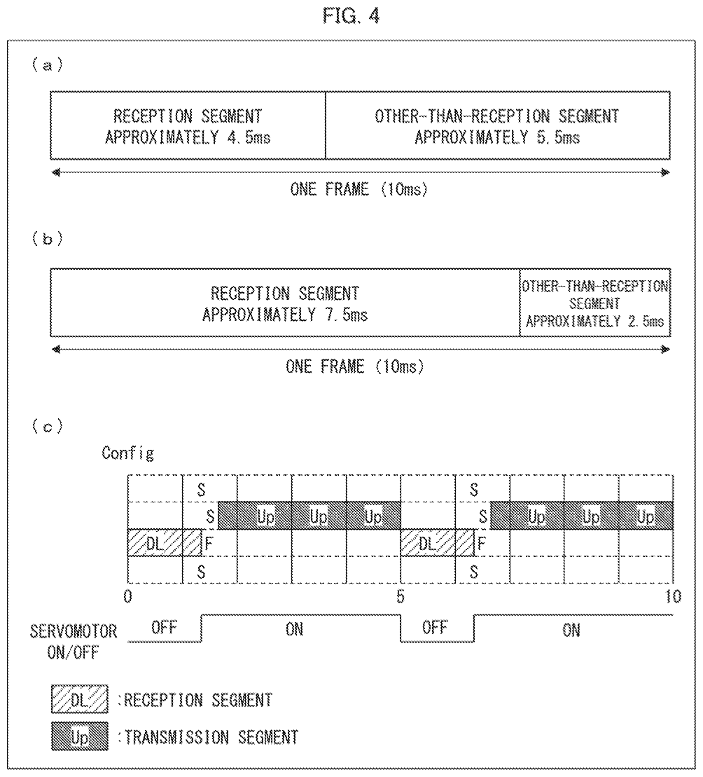

The TDD method is one of communication methods, and differs from the other communication methods in that an identical frequency is used for both transmitting and receiving signals. For the purpose of preventing occurrences of interference between transmission and reception of signals as a result of using an identical frequency for transmitting and receiving the signals, the TDD method is configured as follows. That is, a communication frame for use in communication is divided according to periods of time so that there is a definite distinction between (i) a period of time in which signals can be received (reception segment) and (ii) a period of time in which actions other than receiving signals are possible (other-than-reception segment). The communication frame will be described later in detail with reference to FIG. 4.

(Frame Structure of Communication Frame used in TDD Method)

A frame structure of a communication frame used in the TDD method will be described below with reference to FIG. 4. FIG. 4 is a set of views illustrating the frame structures of the communication frames used in the TDD method. (a) of FIG. 4 is a view schematically illustrating a frame structure in a case where (i) one frame is 10 ms and (ii) a reception segment is approximately 4.5 ms. (b) of FIG. 4 is a view schematically illustrating a frame structure in a case where (i) one frame is 10 ms and (ii) a reception segment is approximately 7.5 ms. (c) of FIG. 4 is a view schematically illustrating a frame structure of a communication frame which (i) is configured so that one frame is 10 ms and (ii) is used in actual communication.

(a) of FIG. 4 illustrates the frame structure of the communication frame in a case where (i) one frame is 10 ms and (ii) a reception segment is approximately 4.5 ms. In a case where communication is carried out by use of a TDD method in which this frame structure is used, the operation control section 142 of the robot 1 in accordance with Embodiment 2 restrains an operation of the servomotor 130 for approximately 4.5 ms, per frame, which corresponds to the reception segment. In addition, the operation control section 142 can cancel the restraint for approximately 5.5 ms which corresponds to the other-than-reception segment, so as to allow the servomotor 130 to operate.

(b) of FIG. 4 illustrates the frame structure of the communication frame in a case where (i) one frame is 10 ms and (ii) a reception segment is approximately 7.5 ms. This frame structure is identical to that of (a) of FIG. 4 except each segment per frame differs in length from a corresponding one in (a) of FIG. 4. Therefore, in a case where communication is carried out by use of a TDD method in which this frame structure is used, the operation control section 142 restrains the operation of the servomotor 130 for approximately 7.5 ms which corresponds to the reception segment.

As illustrated in (c) of FIG. 4, in the actual frame structure, switching between the reception segment and the other-than-reception segment is carried out a plurality of times per communication frame. In the example of FIG. 4, “DL” indicates the reception segment, and “Up” indicates a transmission segment. Note that the other-than-reception segments described in the examples of (a) and (b) of FIG. 4 include “segments which are neither reception segments nor transmission segments”, called special subframes. In the example of FIG. 4, the special subframes are blank segments which are inserted as “SSF” in a case where switching is carried out from a reception segment to a transmission segment. According to the TDD method, interference between transmission and reception of signals is restrained by thus inserting special subframes.

As illustrated in of FIG. 4, the robot 1 in accordance with Embodiment 2 controls an operation of the servomotor 130 so as to (i) switch the servomotor 130 into an “OFF” state during a reception segment and (ii) switch the servomotor 130 into an “ON” state with a timing of switching from a reception segment to an other-than-reception segment. Note that the “ON” state and the “OFF” state can correspond to an “operating” state and a “non-operating” state of the servomotor 130, respectively. Alternatively, the “ON” state and the “OFF” state can correspond to a “restraint being cancelled” state and a “restraint being carried out” state of the servomotor 130, respectively.

In a case where the communication state detecting section 141 of the robot 1 in accordance with Embodiment 2 detects that the communication method used by the communication section 120 for communication is a TDD method, the communication state detecting section 141 identifies a frame structure of a communication frame used in the TDD method. That is, there are a plurality of types of communication frames, including those illustrated in (a) and (b) of FIG. 4, which can be used by the communication section 120 for carrying out communication by use of a TDD method. In a case where the communication state detecting section 141 identifies the frame structure, the communication state detecting section 141 measures, with use of, for example, a timer (not illustrated), an elapsed time from a time point at which the communication frame was started. Then, the communication state detecting section 141 identifies a reception segment, based on the elapsed time. Therefore, while the communication section 120 can receive signals in the frame structure of the communication frame, restraint of the operation of the servomotor 130 can be carried out so as to restrain the occurrence of a noise. During other periods of time, the servomotor 130 can be operated without restraint.

(Flow of Process)

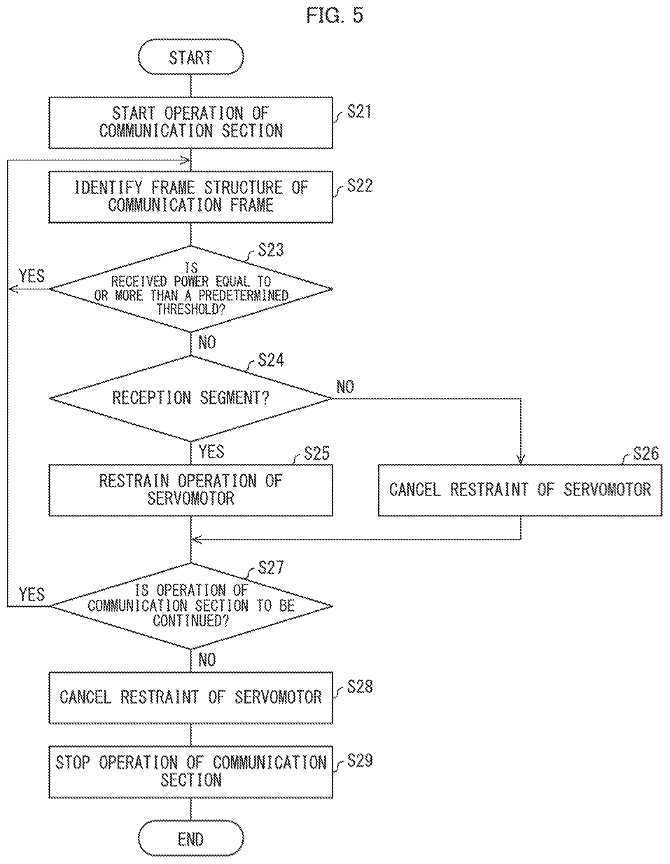

A flow of a process carried out by the robot 1 in accordance with Embodiment 2 of the present invention will be described below with reference to FIG. 5. FIG. 5 is a flowchart illustrating the flow of a process carried out by the robot 1.

First, in accordance with an instruction of the control section 140, the communication section 120 starts an operation (S21). Then, the communication state detecting section 141 detects a communication method used by the communication section 120 for communication. In a case where the communication method thus detected is a TDD method, the communication state detecting section 141 identifies a frame structure of a communication frame used in the TDD method (S22: communication state detecting step). Then, the communication state detecting section 141 detects received power of a signal externally received by the communication section 120, and then determines whether or not a value of the received power is equal to or more than a predetermined threshold (S23: communication state detecting step). In a case where the value of the received power is equal to or more than the predetermined threshold (YES in S23), the process proceeds to S22, and proceeds to S22 and S23 again. In a case where the value of the received power is not equal to or more than the predetermined threshold (NO in S23), the process proceeds to S24.

In S24, the communication state detecting section 141 measures, with use of, for example, a timer (not illustrated), an elapsed time from a time point at which the communication frame was started, and then determines whether or not a current segment is a reception segment in the communication frame (S24: communication state detecting step). In a case where it is determined that the current segment is a reception segment (YES in S24), the operation control section 142 carries out restraint of an operation of the servomotor 130 in accordance with an instruction of the control section 140 (S25: operation controlling step). In contrast, in a case where it is determined that the current segment is not a reception segment (NO in S24), the operation control section 142 cancels the restraint of the operation of the servomotor 130 in accordance with an instruction of the control section 140 (S26: operation controlling step). Note that any of S25 and S26 is carried out, irrespective of whether or not the operation of the servomotor 130 is restrained before any of S25 and S26.

After S25 or S26, the control section 140 determines whether or not the operation of the communication section 120 is to be continued (S27). In a case where it is determined that the operation of the communication section 120 is to be continued (YES in S27), the process proceeds to S22, and proceeds to S22 through S27 again. In contrast, in a case where it is determined that the operation of the communication section 120 is not to be continued (NO in S27), the operation control section 142 cancels, in accordance with an instruction of the control section 140, the restraint of the operation of the servomotor 130 (S28: operation controlling step). Then, the control section 140 stops the operation of the communication section 120 (S29). Then, the process ends.

With the process described above, in a case where the communication section 120 carries out communication by a TDD method, the following is true. That is, the robot 1 in accordance with Embodiment 2 can carry out restraint of an operation of the servomotor 130 in a case where (i) a value of received power of a signal received by the communication section 120 is less than the predetermined threshold and (ii) a current segment is a reception segment. Furthermore, the robot 1 in accordance with Embodiment 2 can cancel the restraint of the operation of the servomotor 130 in a case where (i) a value of received power of a signal received by the communication section 120 is less than the predetermined threshold and (ii) a current segment is an other-than-reception segment. Therefore, while the communication section 120 can receive signals in the frame structure of the communication frame, the occurrence of a noise generated by the servomotor 130 can be restrained. During other periods of time, the servomotor 130 can be operated without restraint.

### Embodiment 3

Embodiment 3 of the present invention will be described below with reference to FIGS. 1, 4, and 6. For convenience, members which are identical in function to the members described in Embodiments 1 and 2 will be given respective identical reference signs, and descriptions of those members will not be repeated.

(Configuration of Robot)

A configuration of a robot 1 in accordance with Embodiment 3 is basically identical to that of the robot 1 in accordance with Embodiment 2 except part of the configuration. Embodiment 3 differs from Embodiment 2 in that an operation control section 142 controls a servomotor 130 to operate at an operation speed according to a frame structure.

(Setting of Operation Speed According to Frame Structure)

The following description will discuss, with reference to (a) and (b) of FIG. 4, how the operation control section 142 of the robot 1 in accordance with Embodiment 3 sets an operation speed of the servomotor 130 according to a frame structure. For simplicity, the following description will assume that during a reception segment of a communication frame, the operation control section 142 restrains an operation speed of the servomotor 130 to 0, that is, the operation control section 142 completely stops the operation of the servomotor 130.

As described in Embodiment 2 with reference to FIG. 4, the communication section 120 can use a plurality of types of communication frames in a case where the communication section 120 carries out communication by use of a TDD method. Note that according to the robot 1 in accordance with Embodiment 2, an operation of the servomotor 130 was restrained in a case where (i) a value of received power is less than the predetermined threshold and (ii) a current segment is a reception segment. This causes a period of time, in which the operation of the servomotor 130 is restrained, to be changed along with a change in length of the reception segment. There was therefore a risk of causing the change in the operation of the servomotor 130 depending on the type of communication frame used for communication, so that the operation of the robot 1 may change.

Note that according to the robot 1 in accordance with Embodiment3, (i) the communication state detecting section 141 identifies a frame structure of a communication frame as in Embodiment 2 and then (ii) the operation control section 142 determines an operation speed of the servomotor 130 according to the frame structure thus identified. In accordance with an instruction of the control section 140, the operation control section 142 controls the servomotor 130 to operate at the operation speed thus determined. This makes it possible, irrespective of the frame structure, to carry out control so that a distance (which is nearly equal to “angle”), in which the servomotor 130 operates in the communication frame, is constant.

Assume that, for example, v1 is a speed at which the servomotor 130 is controlled by the operation control section 142 to operate during an other-than-reception segment in a case where the communication section 120 carries out communication with use of the frame structure illustrated in (a) of FIG. 4. Likewise, assume that v2 is a speed at which the servomotor 130 is controlled by the operation control section 142 to operate during an other-than-reception segment in a case where the communication section 120 carries out communication with use of the frame structure illustrated in (b) of FIG. 4. In this configuration, values of v1 and v2 are set so that respective distances, each of which is obtained by multiplying the operation speed by an other-than-reception segment and in each of which the servomotor 130 operates, are constant, irrespective of the frame structures. Specifically, based on the examples of (a) and (b) of FIG. 4, v1 and v2 are set so that the respective distances, in each of which the servomotor 130 operates per communication frame, satisfy the following equation:

v1×5.5 (ms)=v2×2.5 (ms)

The robot 1 in accordance with Embodiment 3 is thus configured to (i) determine an operation speed of the servomotor 130 according to a frame structure of a communication frame and then control the servomotor 130 to operate at the operation speed thus determined. This allows the robot 1 in accordance with Embodiment 3 to carry out a constant operation, irrespective of a frame structure.

Note that is also possible to determine an operation speed of the servomotor 130 so that a distance in which the servomotor 130 operates in the following case is equal to the above-described distance: a case where a value of received power is equal to or more than a predetermined threshold so that is unnecessary to restrain the operation of the servomotor 130 during a reception segment. Specifically, assume that v0 is the operation speed in the case where the value of the received power is equal to or more than the predetermined threshold so that it is unnecessary to restrain the operation of the servomotor 130 even during a reception segment. In this case, it is possible to set v0 so as to satisfy the following equation:

v0×10 (ms)=v1×5.5 (ms)=v2×2.5 (ms)

(Flow of Process)

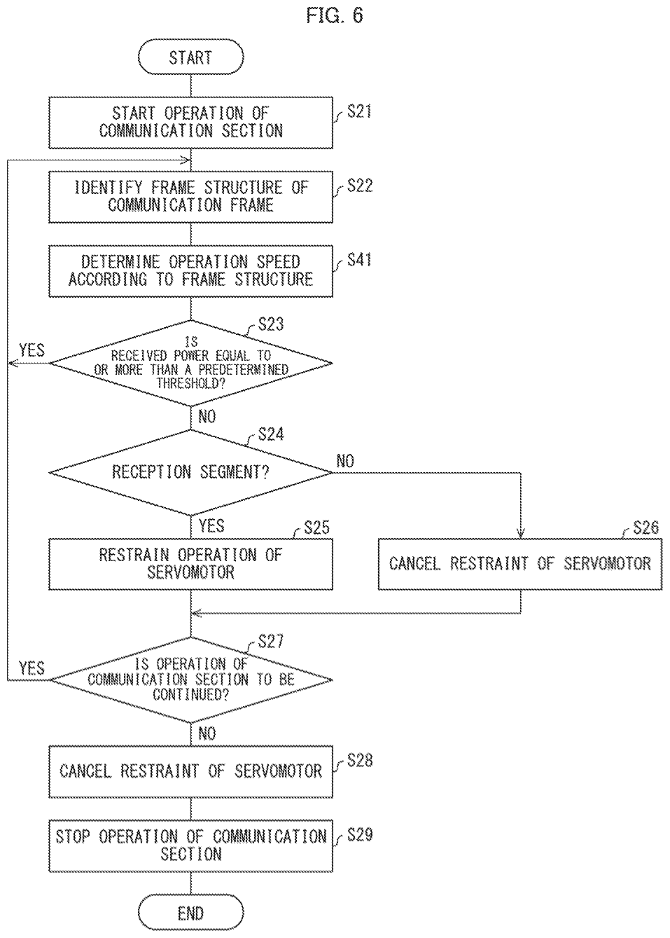

A flow of a process carried out by the robot 1 in accordance with Embodiment 3 of the present invention will be described below with reference to FIG. 6. FIG. 6 is a flowchart illustrating the flow of a process carried out by the robot 1.

The flow of an entire process is identical to that of the flowchart for the process of the robot 1 in accordance with Embodiment 2. However, the flow in Embodiment 3 differs in that S41, which is a new step, is carried out during a period of time which is (i) after S22 is carried out and (ii) before S23 is carried out.

In S41, the operation control section 142 determines an operation speed of the servomotor 130 according to a frame structure identified by the communication state detecting section 141 in S22 (S41: communication state detecting step). Then, the process proceeds to S23, and carries out S23 through S29 as in Embodiment 2.

In a case where the communication section 120 carries out communication by use of a TDD method, the robot 1 in accordance with Embodiment 3 can thus control the servomotor 130 to operate at an operation speed according to a frame structure of a communication frame. For example, assume a case where a period of time, in which it is unnecessary to restrain the operation of the servomotor 130 per communication frame, differs depending on the frame structure. In this case, the operation speed of the servomotor 130 can be made to vary so that a predetermined operation can be completed, irrespective of the frame structure.

[Variation]

Embodiments 1 and 2 each discussed the configuration in which the operation control section 142 restrained the operation of the servomotor 130 according to, for example, the communication state of the communication section 120, which communication state is detected by the communication state detecting section 141. Alternatively, the configuration can be set in reverse order. Specifically, a control section 140 can serve as an operation state detecting section which detects an operation state of a servomotor 130, which operation state is controlled by the operation control section 142. Alternatively, a control section 140 can serve as a communication control section which controls an operation of a communication section 120 according to an operation state of a servomotor 130, which operation state is detected by an operation state detecting section. More specifically, the control section 140 can restrain reception of signals by the communication section 120 while the servomotor 130 is operating.

According to the configuration, reception of signals by the communication section 120 is restrained while the servomotor 130 is operating. This makes it possible to restrain an effect, on a received signal, of a noise generated by the operation of the servomotor 130. Therefore, it is possible to restrain the effect of the noise in a case where signals are received. It is therefore possible to provide a robot 1 having a high degree of design freedom because it includes a control section 140 capable of maintaining a suitable S/N ratio even in a case where, for example, a servomotor 130 which generates larger noise is used.

[Software Implementation Example]

Control blocks of the robot 1 (particularly, the communication state detecting section 141 and the operation control section 142) can be realized by a logic circuit (hardware) provided in an integrated circuit (IC chip) or the like or can be alternatively realized by software.

In the latter case, the robot 1 includes a computer that executes instructions of a program that is software realizing the foregoing functions. The computer, for example, includes at least one processor (control device) and at least one computer-readable storage medium storing the program. An object of the present invention can be achieved by the processor of the computer reading and executing the program stored in the storage medium. Examples of the processor encompass a central processing unit (CPU). Examples of the storage medium encompass a “non-transitory tangible medium” such as a read only memory (ROM), a tape, a disk, a card, a semiconductor memory, and a programmable logic circuit. The computer may further include a random access memory (RAM) or the like in which the program is loaded. Further, the program may be supplied to or made available to the computer via any transmission medium (such as a communication network and a broadcast wave) which allows the program to be transmitted. Note that an aspect of the present invention can also be achieved in the form of a computer data signal in which the program is embodied via electronic transmission and which is embedded in a carrier wave.

Note that although the embodiments discussed a robot as an example, devices to which the present invention is applicable are not limited to robots. The present invention is applicable to any products (electronic devices) such as a refrigerator, an air conditioner, and an electric fan each having an Internet of Things (IoT) function, provided that the product includes a motor and a communication section.

Aspects of the present invention can also be expressed as follows:

A control device in accordance with Aspect 1 of the present invention is a control device for controlling an operation of a motor, including: a communication state detecting section configured to detect a communication state of a communication device; and an operation control section configured to control the operation of the motor, the operation control section being configured to restrain the operation, in a case where received power of a signal, which is externally received by the communication device, is less than a predetermined threshold.

According to the configuration, the operation of the motor is restrained in a case where a value of received power in the communication device is less than a predetermined threshold. This makes it possible to restrain an effect, on a received signal, of a noise generated by the operation of the motor. It is therefore possible to restrain generation of a noise in a case where received power of a received signal is decreased. This makes it advantageously possible to provide a control device having a high degree of design freedom because of the capability to maintain a suitable S/N ratio even in a case where, for example, a motor which generates large noise is used.

The control device in accordance with Aspect 2 of the present invention can be configured in Aspect 1 so that the operation control section is configured to restrain the operation while the signal is being externally received by the communication device. With the configuration, it is possible to (i) restrain the generation of a noise by the motor only during a period of time in which the communication device is actually receiving signals and (ii) allow the motor to operate without any restraint during other periods of time.

The control device in accordance with Aspect 3 of the present invention can be configured in Aspect 1 or 2 so that the operation control section is configured to cancel the restraint of the operation, in at least one of (i) a case where the received power becomes equal to or more than the predetermined threshold while the restraint of the operation is being carried out, (ii) a case where the communication device is no longer receiving the signal while the restraint of the operation is being carried out, and (iii) a case where the communication device stops carrying out communication while the restraint of the operation is being carried out.

With the configuration, it is possible to allow the motor to operate without any restraint in a case where at least one of the following (i) through (iii) is met: (i) the value of the received power becomes equal to or more than a predetermined threshold, so that the effect of a noise can be ignored, (ii) no signal is being received, so that it is unnecessary to consider a noise to received signals, and (iii) the communication device stops carrying out communication, so that the effect of the operation of the motor on received signals can be ignored.

The control device in accordance with Aspect 4 of the present invention can be configured in any one of Aspects 1 through 3 so that: the communication state detecting section is configured to further detect a communication method used by the communication device for exchanging signals; and the operation control section is configured to carry out the restraint of the operation, in a case where (i) the communication method thus detected is a TDD method and (ii) a signal can be externally received by the communication device.

With the configuration, the operation of the motor can be restrained in a case where (i) the communication device carries out communication by use of a TDD method and (ii) the communication device can externally receive signals. This makes possible to (i) restrain the generation of a noise by the motor while the communication device can receive signals and (ii) allow the motor to operate without any restraint during other periods of time.

The control device in accordance with Aspect 5 of the present invention can be configured in Aspect 4 so that the communication state detecting section is configured to identify: a frame structure of a communication frame for use in the TDD method; and a period of time in which the signal can be received, based on an elapsed time from a time point at which the communication frame started.

With the configuration, the following is true: In a case where the communication device carries out communication by use of a TDD method, it is possible to identify, based on an elapsed time from a time point at which the communication frame started, whether or not a current period of time is a period in which the communication device can receive signals in the frame structure of the communication frame. This makes it possible, in a frame structure of a communication frame, to (i) restrain the generation of a noise by the motor while the communication device can receive signals and (ii) allow the motor to operate without any restraint during other periods of time.

The control device in accordance with Aspect 6 of the present invention can be configured in Aspect 5 so that the operation control section is configured to control the motor to operate at an operation speed in accordance with the frame structure.

With the configuration, the following is true: In a case where the communication device carries out communication by use of a TDD method, it is possible to control the motor to operate at an operation speed in accordance with a frame structure of a communication frame. For example, assume a case where a period, in which it is unnecessary to restrain the operation of the motor per communication frame, differs depending on the frame structure. In this case, the operation speed of the motor can be made to vary so that a predetermined operation can be completed, irrespective of the frame structure. p The control device in accordance with Aspect 7 of the present invention can be configured in any one of Aspects 1 through 6 so that the motor is a brushed motor; and the operation control section is configured to carry out restraint of a rotation speed of the brushed motor. With the configuration, it is possible to restrain an effect, on a signal received by the communication device, of a noise generated by rotation of the brushed motor.

A control device in accordance with Aspect 8 of the present invention is a control device for controlling an operation of a communication device, including: an operation state detecting section configured to detect an operation state of a motor; and a communication control section configured to control the operation of the communication device, the communication control section being configured to restrain reception of a signal by the communication device while the motor is operating.

According to the configuration, reception of signals by the communication device is restrained while the motor is operating. This makes it possible to restrain an effect, on a received signal, of a noise generated by the operation of the motor. This makes it possible to restrain the effect of a noise during reception of signals, and therefore makes it advantageously possible to provide a control device having a high degree of design freedom because of the capability to maintain a suitable S/N ratio even in a case where, for example, a motor which generates large noise is used.

An electronic device in accordance with Aspect 9 of the present invention is an electronic device including: at least one communication device; at least one motor; and at least one control device, the at least one control device being configured to carry out: a communication state detecting process of detecting a communication state of the at least one communication device; and an operation control process of controlling an operation of the at least one motor, in the operation control process, the operation is restrained in a case where received power of a signal, which is externally received by the at least one communication device, is less than a predetermined threshold. With the configuration, it is possible to bring about a working effect similar to that of Aspect 1.

A control method in accordance with Aspect 10 of the present invention is a method of controlling an electronic device, the electronic device including: at least one communication device; at least one motor; and at least one control device, the method including the steps of: (a) detecting a communication state of the at least one communication device; and (b) controlling an operation of the at least one motor, the step (b) being carried out so as to restrain the operation in a case where received power of a signal, which is externally received by the at least one communication device, is less than a predetermined threshold. With the configuration, it is possible to bring about a working effect similar to that of Aspect 1.

A control device in accordance with each aspect of the present invention can be realized by a computer. The computer is operated based on (i) a control program for causing the computer to realize the control device by causing the computer to operate as each section (software element) included in the control device and (ii) a computer-readable storage medium in which the control program is stored. Such a control program and a computer-readable storage medium are included in the scope of the present invention.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 Robot (electronic device)
110 Storage section
120 Communication section
130 Servomotor (motor)
140 Control section (operation state detecting section, communication control section)
141 Communication state detecting section
142 Operation control section

1. A control device for controlling an operation of a motor, comprising:
a communication state detecting section configured to detect a communication state of a communication device; and
an operation control section configured to control the operation of the motor,
the operation control section being configured to restrain the operation, in a case where received power of a signal, which is externally received by the communication device, is less than a predetermined threshold.

2. The control device as set forth in claim 1, wherein
the operation control section is configured to restrain the operation while the signal is being externally received by the communication device.

3. The control device as set forth in claim 1, wherein
the operation control section is configured to cancel the restraint of the operation, in at least one of (i) a case where the received power becomes equal to or more than the predetermined threshold while the restraint of the operation is being carried out, a case where the communication device is no longer receiving the signal while the restraint of the operation is being carried out, and (iii) a case where the communication device stops carrying out communication while the restraint of the operation is being carried out.

4. The control device as set forth in claim 1, wherein:
the communication state detecting section is configured to further detect a communication method used by the communication device for exchanging signals; and
the operation control section is configured to carry out the restraint of the operation, in a case where (i) the communication method thus detected is a TDD method and (ii) signal can be externally received by the communication device.

5. The control device as set forth in claim 4, wherein
the communication state detecting section is configured to identify:
a frame structure of a communication frame for use in the TDD method; and
a period of time in which the signal can be received, based on an elapsed time from a time point at which the communication frame started.

6. The control device as set forth in claim 5, wherein
the operation control section is configured to control the motor to operate at an operation speed in accordance with the frame structure.

7. The control device as set forth in claim 1, wherein:
the motor is a brushed motor; and
the operation control section is configured to carry out restraint of a rotation speed of the brushed motor.

8. A control device for controlling an operation of a communication device, comprising:
an operation state detecting section configured to detect an operation state of a motor; and
a communication control section configured to control the operation of the communication device,
the communication control section being configured to restrain reception of a signal by the communication device while the motor is operating.

9. An electronic device comprising:
at least one communication device;
at least one motor; and
at least one control device,
said at least one control device being configured to carry out:
a communication state detecting process of detecting a communication state of the at least one communication device; and
an operation control process of controlling an operation of the at least one motor,
in the operation control process, the operation is restrained in a case where received power of a signal, which is externally received by the at least one communication device, is less than a predetermined threshold.

10. A method of controlling an electronic device,
said electronic device comprising:
at least one communication device;
at least one motor; and
at least one control device,
said method comprising the steps of:
(a) detecting a communication state of the at least one communication device; and
(b) controlling an operation of the at least one motor, the step (b) being carried out so as to restrain the operation in a case where received power of a signal, which is externally received by the at least one communication device, is less than a predetermined threshold.
